(19) United States
(12) Patent Application Publication
(10) Pub. No.: US 2024/0003355 A1
(43) Pub. Date: Jan. 4, 2024

(54) OSCILLATING STRUCTURE WITH TWO SIDES FIXED AND MIDDLE CAPABLE OF MAKING RECIPROCATING ROTATION

(71) Applicant: Shenzhen Aisi Technology Limited, Shenzhen (CN)

(72) Inventors: Yuan XU, Shenzhen (CN); Weirun FENG, Shenzhen (CN)

(73) Assignee: Shenzhen Aisi Technology Limited, Shenzhen (CN)

(21) Appl. No.: 17/871,947

(22) Filed: Jul. 24, 2022

(30) Foreign Application Priority Data
Jul. 4, 2022 (CN) 202210787312.6

(51) Int. Cl. F04D 25/10; F04D 29/056

(52) U.S. Cl. CPC F04D 25/105; F04D 29/056

(57) ABSTRACT

The disclosure relates to an oscillating structure with two sides fixed and a middle capable of making reciprocating rotation, which belongs to the technical field of fans. The oscillating structure comprises a hardware support, a right plastic support, a driving mechanism, a left plastic support, a driven mechanism and a rotary swinging mechanism. According to the disclosure, through the cooperation of the driving mechanism and the driven mechanism with the rotary swinging mechanism, and under the driving of the driving mechanism and with the cooperation of the driven mechanism, the rotary swinging mechanism achieves the effect of horizontal or vertical placement or oscillating at any angle of 360 degrees, thus being more practical.

### CROSS-REFERENCE TO RELATED APPLICATIONS

The application claims priority to Chinese patent application No. 202210787312.6, filed on Jul. 4, 2022, the entire contents of which are incorporated herein by reference.

### TECHNICAL FIELD

The disclosure relates to the technical field of fans, in particular to an oscillating structure with two sides fixed and a middle capable of making reciprocating rotation.

### BACKGROUND

A fan refers to a tool for cooling by generating wind in hot days. The electric fan is a device which is driven by electricity to generate an air flow, and a fan body arranged in the electric fan rotates after being electrified, so that mechanical energy is converted into wind energy, and natural wind is generated to achieve a cooling effect.

A traditional fan has a fixed structure and can only blow towards a specific direction. Therefore, people have designed an oscillating fan to blow back and forth in the horizontal direction, increasing the blowing area and improving the practicability. However, the existing oscillating fan can only be vertically placed on the ground to oscillate left and right.

### SUMMARY

The purpose of the disclosure is to provide an oscillating structure with two sides fixed and a middle capable of making reciprocating rotation, so as to solve the problems mentioned in the background above.

To achieve the purpose above, the disclosure provides the following technical solution:

an oscillating structure with two sides fixed and a middle capable of making reciprocating rotation, comprising:
a hardware support;
a right plastic support fixedly mounted at one end of the hardware support;
a driving mechanism mounted on the right plastic support;
a left plastic support fixedly mounted at one end of the hardware support far away from the right plastic support;
a driven mechanism mounted on the left plastic support;
a rotary swinging mechanism, wherein one end of the rotary swinging mechanism is connected with the driving mechanism and the other end thereof is connected with the driven mechanism, and the rotary swinging mechanism is driven to rotate when the driving mechanism rotates.

As a further technical solution of the disclosure, the driving mechanism comprises:
a motor mounted in the right plastic support;
a right fixing piece fixedly mounted on the right plastic support and used for fixing the motor;
a gear mounted at an output end of the motor, wherein the gear cooperates with the rotary swinging mechanism.

As a further technical solution of the disclosure, the driven mechanism comprises:
a left fixing piece fixedly mounted on the left plastic support and cooperating with the rotary swinging mechanism;
As a still further technical solution of the disclosure, the rotary swinging mechanism comprises:
a middle oscillating assembly A;
a middle oscillating assembly B mounted at one side of the middle oscillating assembly A and cooperating with the middle oscillating assembly A;
a rotary swinging assembly A fixedly mounted at one end of the middle oscillating assembly A and fixedly connected with one end of the middle oscillating assembly B, wherein the rotary swinging assembly A is rotatably mounted in the right fixing piece and cooperates with the gear;
a rotary swinging assembly B fixedly mounted at one end of the middle oscillating assembly A far away from the rotary swinging assembly A and fixedly connected with the middle oscillating assembly B, wherein the rotary swinging assembly B is mounted in and rotatably connected with the left fixing piece.

As a still further technical solution of the disclosure, the rotary swinging assembly A is rotatably connected with the right fixing piece by balls.

As a still further technical solution of the disclosure, the rotary swinging assembly B is rotatably connected with the left fixing piece by balls.

As a still further technical solution of the disclosure, a right swinging gland cooperating with the rotary swinging assembly A is fixedly mounted on the right fixing piece.

As a still further technical solution of the disclosure, a left swing gland cooperating with the rotary swinging assembly B is fixedly mounted on the left fixing piece.

Compared with the prior art, the disclosure has the beneficial effects that: through the cooperation of the driving mechanism and the driven mechanism with the rotary swinging mechanism, and under the driving of the driving mechanism and with the cooperation of the driven mechanism, the rotary swinging mechanism achieves the effect of horizontal or vertical placement or oscillating at any angle of 360 degrees, thus being more practical.

### BRIEF DESCRIPTION OF DRAWINGS

FIG. 1 is a sectional view of an oscillating structure with two sides fixed and a middle capable of making reciprocating rotation;

FIG. 2 is an enlarged schematic structural diagram of a part A in FIG. 1;

FIG. 3 is an enlarged schematic structural diagram of a part B in FIG. 1.

In the drawings: 1. hardware support; 2. right plastic support; 3. right fixing piece; 4. right swinging gland, 5. left plastic support; 6. left fixing piece; 7. left swinging gland; 8. motor, 9. gear; 10. rotary swinging assembly A; 11. middle oscillating assembly A; 12. middle oscillating assembly B; 13. rotary swinging assembly B; 14. ball.

### DETAILED DESCRIPTION OF THE EMBODIMENTS

The technical solutions in the embodiments of the disclosure will be clearly and completely described below with reference to the drawings in the embodiments of the disclosure.

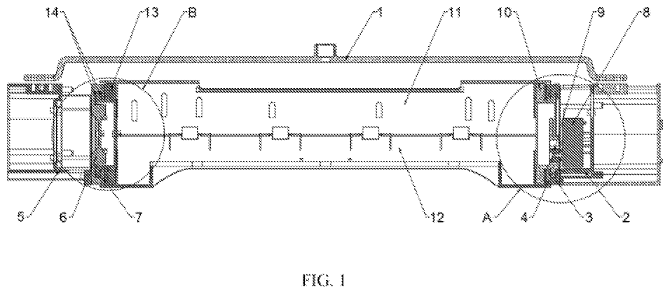

The embodiment of the disclosure is realized as follows: as shown in FIGS. 1-3, an oscillating structure with two sides fixed and a middle capable of making reciprocating rotation comprises:
a hardware support 1;
a right plastic support 2 fixedly mounted at one end of the hardware support 1;
a driving mechanism mounted on the right plastic support 2;
a left plastic support 5 fixedly mounted at one end of the hardware support 1 far away from the right plastic support 2;
a driven mechanism mounted on the left plastic support 5;
a rotary swinging mechanism, wherein one end of the rotary swinging mechanism is connected with the driving mechanism and the other end thereof is connected with the driven mechanism, and the rotary swinging mechanism is driven to rotate when the driving mechanism rotates.

In practical application of the disclosure, the hardware support 1 can be fixed at any suitable position, and under the driving of the driving mechanism and with the cooperation of the driven mechanism, the rotary swinging mechanism achieves the effect of horizontal or vertical placement or oscillating at any angle of 360 degrees, thus being more practical.

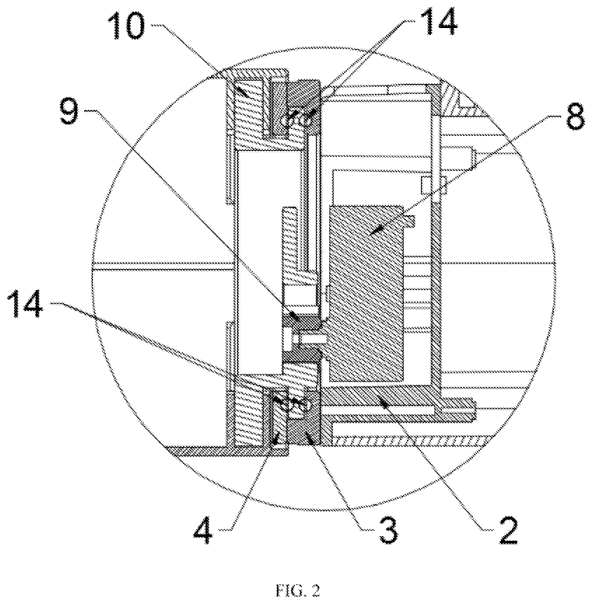

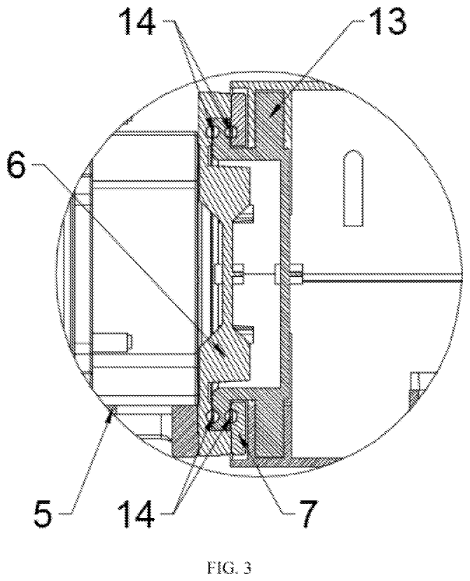

As shown in FIGS. 2 and 3, as one preferred embodiment of the disclosure, the driving mechanism comprises:
a motor 8 mounted in the right plastic support 2;
a right fixing piece 3 fixedly mounted on the right plastic support 2 and used for fixing the motor 8;
a gear 9 mounted at an output end of the motor 8, wherein the gear 9 cooperates with the rotary swinging mechanism;
the driven mechanism comprises:
a left fixing piece 6 fixedly mounted on the left plastic support 5 and cooperating with the rotary swinging mechanism;
the rotary swinging mechanism comprises:
a middle oscillating assembly A11;
a middle oscillating assembly B12 mounted on one side of the middle oscillating assembly A11 and cooperating with the middle oscillating assembly A11;
a rotary swinging assembly A10 fixedly mounted at one end of the middle oscillating assembly A11 and fixedly connected with one end of the middle oscillating assembly B12, wherein the rotary swinging assembly A10 is rotatably mounted in the right fixing piece 3 and cooperates with the gear 9;
a rotary swinging assembly B13 fixedly mounted at one end of the middle oscillating assembly A11 far away from the rotary swinging assembly A10 and fixedly connected with the middle oscillating assembly B12, wherein the rotary swinging assembly B13 is mounted in and rotatably connected with the left fixing piece 6.

In one case of this embodiment, when swinging, the motor 8 drives the gear 9 to rotate, and the gear 9 drives the rotary swinging assembly A10 to rotate. In order to improve the rotation stability, the rotary swinging assembly A10 is rotatably connected with the right fixing piece 3 through balls 14, and a right swinging gland 4 cooperating with the rotary swinging assembly A10 is fixedly mounted on the right fixing piece 3, that is, the rotary swinging assembly A10 is pressed by the right swinging gland 4, and under the action of balls 14, the friction between the rotary swinging assembly A10 and the right fixing piece 3 is reduced, thus ensuring the rotation stability of the rotary swinging assembly A10. When the rotary swinging assembly A10 rotates, the middle oscillating assembly A11 and the middle oscillating assembly B12 are driven to rotate, and at this time the rotary swinging assembly B13 is driven to rotate. In order to ensure the rotation stability of the rotary swinging assembly B13, the rotary swinging assembly B13 is rotatably connected with the left fixing piece 6 through balls 14, and a left swinging gland 7 cooperating with the rotary swinging assembly B13 is fixedly mounted on the left fixing piece 6, that is, the rotary swinging assembly B13 is pressed by the left swinging gland 7, and under the action of the balls 14 the friction between the rotary swinging assembly B13 and the left fixing piece 6 is greatly reduced.

Working principle: during connection, the right plastic support 2 and the left plastic support 5 are fixed by the hardware support 1; the right fixing piece 3 is fixed by the right plastic support 2; the left fixing piece 6 is fixed by the left plastic support 5; the motor 8 is fixed by the right plastic support 2; a motor output shaft of the motor 8 rotates to drive the gear 9 to rotate; the gear 9 drives the rotary swinging assembly A10 to rotate; the rotary swinging assembly A10 is connected and fixed with the middle oscillating assembly A11 and the middle oscillating assembly B12, so the rotary swinging assembly A10 drives the middle oscillating assembly A11 and the middle oscillating assembly B12 to synchronously rotate and oscillate; the middle oscillating assembly A11 and the middle oscillating assembly B12 drive the rotary swinging assembly B13 to rotate; a bottom surface of the rotary swinging assembly A10 is supported by the right fixing piece 3 and the balls 14; a top surface of the rotary swinging assembly A10 is pressed by the right swinging gland 4 and the balls 14; a bottom surface of the rotary swinging assembly B13 is supported by the left fixing piece 6 and the balls 14; a top surface of the rotary swinging assembly B13 is pressed by the left swinging gland 7 and the balls 14; and finally, the effect that the middle oscillating assembly A11 and the middle oscillating assembly B12 can be placed horizontally or vertically or oscillate at any angle of 360 degrees is realized.

It will be evident to those skilled in the art that the disclosure is not limited to the details of the foregoing exemplary embodiments, and that the disclosure may be embodied in other specific forms without departing from the spirit or essential features thereof. The present embodiments are therefore to be considered in all respects as illustrative and not restrictive, and the scope of the disclosure is indicated by the appended claims rather than by the foregoing description, and all changes which come within the meaning and range of equivalents of the claims are therefore intended to be embraced therein. Any reference sign in a claim should not be construed as limiting the claim concerned.

In addition, it should be understood that although this specification describes embodiments, not every embodiment includes only an independent technical solution, and such description is for clarity purposes only, and it is to be understood that all embodiments may be combined as appropriate by one of ordinary skill in the art to form other embodiments as will be apparent to those skilled in the art from the description herein.

What is claimed is:

1. An oscillating structure with two sides fixed and a middle capable of making reciprocating rotation, comprising:
a hardware support;
a right plastic support fixedly mounted at one end of the hardware support;
a driving mechanism mounted on the right plastic support;
a left plastic support fixedly mounted at one end of the hardware support far away from the right plastic support;
a driven mechanism mounted on the left plastic support;
a rotary swinging mechanism, wherein one end of the rotary swinging mechanism is connected with the driving mechanism and the other end thereof is connected with the driven mechanism, and the rotary swinging mechanism is driven to rotate when the driving mechanism rotates.

2. The oscillating structure with the two sides fixed and the middle capable of making reciprocating rotation of claim 1, wherein the driving mechanism comprises:
a motor mounted in the right plastic support;
a right fixing piece fixedly mounted on the right plastic support and used for fixing the motor,
a gear mounted at an output end of the motor, wherein the gear cooperates with the rotary swinging mechanism.

3. The oscillating structure with the two sides fixed and the middle capable of making reciprocating rotation of claim 2, wherein the driven mechanism comprises:
a left fixing piece fixedly mounted on the left plastic support and cooperating with the rotary swinging mechanism.

4. The oscillating structure with the two sides fixed and the middle capable of making reciprocating rotation of claim 3, wherein the rotary swinging mechanism comprises:
a middle oscillating assembly A;
a middle oscillating assembly B mounted at one side of the middle oscillating assembly A and cooperating with the middle oscillating assembly A;
a rotary swinging assembly A fixedly mounted at one end of the middle oscillating assembly A and fixedly connected with one end of the middle oscillating assembly B, wherein the rotary swinging assembly A is rotatably mounted in the right fixing piece and cooperates with the gear;
a rotary swinging assembly B fixedly mounted at one end of the middle oscillating assembly A far away from the rotary swinging assembly A and fixedly connected with the middle oscillating assembly B, wherein the rotary swinging assembly B is mounted in and rotatably connected with the left fixing piece.

5. The oscillating structure with the two sides fixed and the middle capable of making reciprocating rotation of claim 4, wherein the rotary swinging assembly A is rotatably connected with the right fixing piece by balls.

6. The oscillating structure with the two sides fixed and the middle capable of making reciprocating rotation of claim 4, wherein the rotary swinging assembly 8 is rotatably connected with the left fixing piece by balls.

7. The oscillating structure with the two sides fixed and the middle capable of making reciprocating rotation of claim 4, wherein a right swinging gland cooperating with the rotary swinging assembly A is fixedly mounted on the right fixing piece.

8. The oscillating structure with the two sides fixed and the middle capable of making reciprocating rotation of claim 4, wherein a left swinging gland cooperating with the rotary swinging assembly B is fixedly mounted on the left fixing piece.
